(19) United States
(12) Patent Application Publication
(10) Pub. No.: US 2011/0088528 A1
(43) Pub. Date: Apr. 21, 2011

(54) Machine Tool Monitoring Device

(75) Inventors: Benjamin Visel, Schwieberdingen (DE); Georg Stellmann, Ludwigsburg (DE); Sebastian Jackisch, Ludwigsburg (DE)

(73) Assignee: Robert Bosch GmbH, Stuttgart (DE)

(21) Appl. No.: 12/999,916

(22) PCT Filed: Dec. 9, 2008
(86) PCT No.: PCT/EP2008/067124

§ 371 Date: Dec. 17, 2010

(30) Foreign Application Priority Data
Jun. 18, 2008 (DE) 102008002503.8

(51) Int. Cl. B23Q 11/00

(52) U.S. Cl. 83/365

(57) ABSTRACT

The present invention relates to a machine tool monitoring device having a detecting unit (32) for detecting the presence of at least one type of material in at least one prescribed machine tool region, particularly the machine tool working region (34), by means of spectral analysis of radiation (S_{R}), wherein the detecting unit (32) comprises a sensor unit (44) having at least one sensitivity region (54.2) for detecting radiation in a wavelength range (WL₂) disposed in the electromagnetic range, a transmitting unit (42; 64) for transmitting radiation having at least one radiation component in the wavelength range (WL₂), and an analysis means (58) designed such that it can detect the presence of at least one type of material in at least one prescribed machine tool region based on the radiation detected by the sensor unit (44), wherein the analysis means (58) is operationally coupled to the transmitting unit (42).

The invention is based on a machine tool monitoring device according to the precharacterizing clause of claim 1.

A machine tool monitoring device having a recognition unit for recognition of material is known.

### ADVANTAGES OF THE INVENTION

The invention is based on a machine tool monitoring device having a recognition unit which is provided in order to recognize the presence of at least one type of material in at least one predetermined machine tool area, in particular a machine tool working area, by means of the spectral evaluation of radiation.

It is proposed that the recognition unit have a sensor unit having at least one sensitivity range for radiation detection in a wavelength range which is arranged in the electromagnetic range, in particular at least partially in the infrared spectrum.

This makes it possible to achieve reliable and rapid recognition of a situation in which a machine tool is being used, in a cost-effective manner.

The expression “machine tool working area” is intended to mean, in particular, an area of a machine tool in the immediate vicinity of a tool. The expression an area in the “immediate” vicinity of the tool is intended to mean, in particular, an area in which each point in the area is at a very short distance from the tool, which is a maximum of 10 cm, preferably a maximum of 5 cm, and particularly preferably a maximum of 2 cm.

In this context, “radiation” means, in particular, electromagnetic radiation. A “spectrum” of radiation detected by the sensor unit is intended to mean, in particular, a distribution of a radiation characteristic variable, in particular of the intensity of the radiation, as a function of the wavelength, the frequency and/or the time. Furthermore, “spectral evaluation” of radiation is intended to mean, in particular, signal evaluation in which an evaluation result is obtained by detection of a characteristic of a spectrum of the radiation. In order to achieve rapid evaluation, a characteristic of the spectrum corresponds, in particular, to a signal intensity integrated over a wavelength range.

In order to achieve an evaluation signal with high signal intensity, the recognition unit has a transmitting unit which is provided in order to transmit radiation having at least one radiation component in the wavelength range.

In order to achieve a high degree of safety for use of a machine tool, the recognition unit furthermore has an evaluation means which is designed such that it can detect the presence of at least one type of material in at least one predetermined machine tool area on the basis of the radiation detected by the sensor unit. The at least one type of material is, in particular, human tissue. However, other types of material can, of course, also be detected, for example materials to be machined and/or processed with the aid of the machine tool, the tools of other objects, in particular glove materials, or the like, when this is desired. Furthermore, it is also possible to distinguish between different types of material.

The evaluation means is operatively connected to the transmitting unit. In other words, the evaluation means can detect the presence of at least one type of material in at least one predetermined machine tool area both on the basis of the radiation transmitted by the transmitting unit and on the basis of the radiation detected by the sensor unit. Furthermore, it is advantageously possible to compensate for ambient light by linking the transmitting unit and the receiving unit and by means of time modulation (pulsing) of the transmitted signal and filtering of this time modulation from the received signal.

One preferred embodiment of the invention proposes that the recognition unit is designed for presence recognition by means of the evaluation of a reflection spectrum of radiation which is reflected by an examination object, therefore making it possible to achieve effective recognition, based on contrast detection, of the type of material of the examination object. As has already been mentioned, the examination object may be human tissue, for example a hand, objects which are intended to be machined and/or processed with the aid of the machine tool, other objects, such as gloves worn by an operator, or the like.

Particularly reliable recognition can be achieved if the wavelength range is a near-medium infrared range. This makes it possible to provide a sensitivity range which is specifically matched to the detection and the evaluation of a reflection spectrum. In this context, a “near-medium infrared range” is intended to mean, in particular, a wavelength interval in the infrared spectrum which is arranged below the wavelength 15 μm. Furthermore, high contrast can be achieved between human tissue and a material if the sensitivity range for detection of radiation is provided in a wavelength interval of the infrared spectrum below the wavelength 8 μm. In particular, it is advantageous for the wavelength range to be a near infrared range. In this context, a “near infrared range” is intended to mean, in particular, a wavelength interval in the infrared spectrum which is arranged below the wavelength 1.5 μm, in particular such as a wavelength interval in the IR-A range. The wavelength range can, furthermore, be arranged partially in the visible and/or in the ultra-violet range of the electromagnetic spectrum.

One preferred embodiment of the invention proposes that the wavelength range be a narrow band. In this context, a “narrowband wavelength range” is intended to mean, in particular, a wavelength range which has a maximum bandwidth of 100 nm, advantageously a maximum of 50 nm, preferably a maximum of 20 nm, and particularly preferably a maximum of 10 nm, in which it has been possible to achieve very good results even with a bandwidth of 50 nm. This advantageously means there is no need for filtering of detected radiation, involving a complex design.

A further embodiment of the invention proposes that the transmitting unit be provided to transmit radiation in the wavelength range and in at least one further wavelength range. This makes it possible to produce radiation specifically in desired wavelength ranges, in which case there is no need for complex filtering for detection of the radiation by the sensor unit. Furthermore, a high signal-to-noise ratio can be achieved. This can be achieved particularly easily if the transmitting unit has at least two, and in particular three sensor modules for transmission of radiation in each case in a different wavelength range, and which are operated during operation of the transmitting unit. For example, the transmission can take place successively. “Successive” transmission in two wavelength ranges is intended, in particular, to mean that the transmission in the first wavelength range and the transmission in the second wavelength range very largely do not overlap. In this case, an overlap duration, during which radiation is transmitted simultaneously in both wavelength ranges, is intended to be less than 10%, advantageously less than 5%, and preferably less than 1%, of the shortest transmission duration in one wavelength range. It is particularly advantageous for the transmission processes not to overlap, in which case the transmitting unit emits pulses which are separate from one another. Alternatively, the transmitting unit may, however, also have one or more transmitting diodes, in which case each transmitting diode is designed such that it can transmit radiation in at least two mutually different wavelength ranges.

It is also proposed that the machine tool operating device have an optics unit which is provided to define at least one reaction area of the recognition unit. In particular, a “reaction area” of the recognition unit is intended to mean a spatial area which is associated with a process which can be carried out by the recognition unit and is triggered when a body of the at least one type of material is present in this spatial area. The reaction area preferably corresponds at least to a subarea of the machine tool working area, for example a material coating area, a material removal area, or some other area which results in a potential hazard to the user. Alternatively or additionally, a reaction area can be provided which differs from the machine tool working area. For example, a reaction area such as this can also be used to provide a warning function of the machine tool monitoring device. The optics unit may correspond to an optical system connected in the beam path of the sensor unit. Furthermore, the optics unit may, as an alternative, correspond to an optical system positioned in the beam path of the transmission unit. The optics unit allows the machine tool to be used safely and more conveniently, since a reaction of the recognition unit can be restricted to a limited area.

The operating convenience can furthermore advantageously be improved by the machine tool monitoring device having a marking unit which marks the at least one predetermined machine tool area or the at least one reaction area. Such marking can be provided, for example, by projection of laser light around the area to be marked. Alternatively, the marking can also be performed by the transmitting unit emitting a radiation component in the visible range in the direction of the area to be marked. Other marking methods are, of course, also feasible.

Advantageously, the sensor unit has at least one further sensitivity range, which is provided for radiation detection in a further wavelength range, thus making it possible to achieve even better certainty in the recognition of the type of material. The wavelength ranges may overlap. However, it is advantageous for the wavelength ranges to be separate from one another. Particularly accurate recognition can be achieved if the sensor unit has at least three sensitivity ranges, which are each provided for radiation detection in a different wavelength range.

In this context, it is proposed that the evaluation means be designed such that it can recognize the presence of the at least one type of material on the basis of a ratio of at least two radiation characteristic variables, which are each associated with one radiation component in a different wavelength range. This advantageously allows rapid recognition to be achieved. In particular, there is no need to consider reference radiation. A “radiation characteristic variable” is intended to mean, in particular, a characteristic variable which is detected on the basis of radiation that is incident on the sensor unit. In particular, this characteristic variable may be an electric characteristic variable.

Advantageously, a decision unit is provided, which is designed such that it operates at least one actuating unit on the basis of a detected presence or absence of the at least one type of material. By way of example, the actuator unit may be a tool drive which is switched on or off on the basis of the presence or absence of the at least one type of material in the monitored area. The actuator unit may also be a protection system which protects the operator against contact with a tool, for example a protection system which moves a tool out of a danger area, or a protection system which produces a warning signal in order to make the operator aware of an incipient danger. By way of example, the signal which is produced may be a visual, audible or some other warning signal.

The machine tool monitoring device advantageously has an activation and/or deactivation unit, with the aid of which the machine tool monitoring device can be switched on and/or off by a user. This activation and/or deactivation unit is advantageously designed such that the extent to which the machine tool monitoring device can be activated and/or deactivated by an operator with the aid of this unit is dependent on an authorization level of the user. Such operation of the activation and/or deactivation unit as a function of an authorization level provides the capability to allocate different rights to users with different qualifications. For example, a craftsman may be authorized to completely deactivate the machine tool monitoring device, while an inexperienced trainee may be allocated no deactivation rights. Furthermore, for example, it is feasible to be able to increase or decrease the size of the reaction area as a function of the authorization level of the user. The authorization level of the user can be stored in a portable medium, for example a smartcard, a transponder or the like, in which case the memory medium is read in an appropriate device in order to check the authorization level, and the authorization level is checked. Operating options for the machine tool monitoring device can then be permitted or inhibited by the activation and/or deactivation unit, depending on the detected authorization level.

Furthermore, the present invention relates to a machine tool, in particular a cutting machine tool, such as a circular saw, a drilling machine or the like, having a machine tool monitoring device of the type defined above.

Finally, the present invention relates to an object for use for handling of a machine tool, in which case this object is manipulated such that its material can be detected more easily by the machine tool monitoring device. For example, the surface of the object can be coated with a material which can be detected easily by the machine tool monitoring device. The object is preferably a working glove, which is worn by a user while operating the machine tool.

Further advantages of the present invention will become evident from the following description of the drawing. The drawing illustrates exemplary embodiments of the invention. The drawing, the description and the claims contain numerous features in combination. A person skilled in the art will also expediently consider the features individually, and combine them to make worthwhile further combinations.

In the figures:

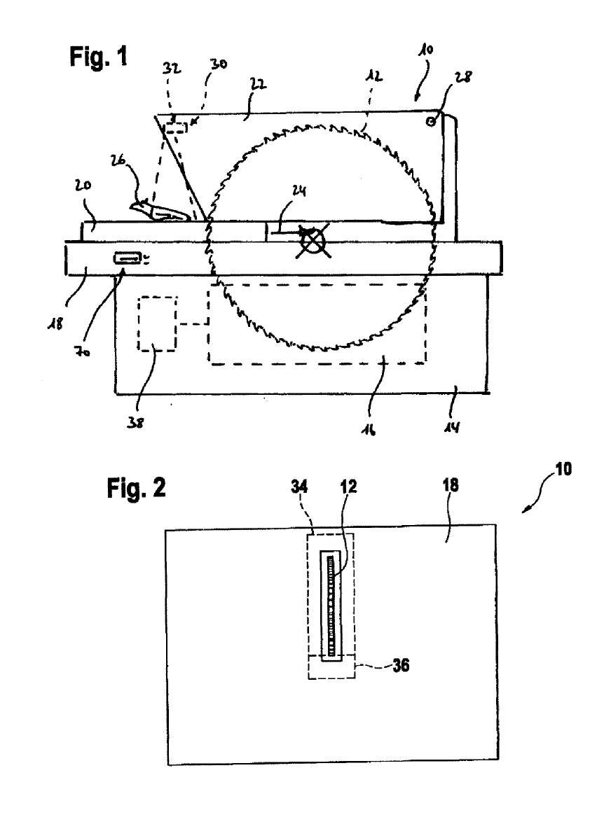

FIG. 1 shows a table-type circular saw with a recognition unit,

FIG. 2 shows the table-type circular saw in the form of a plan view from above, with a reaction area of the recognition unit,

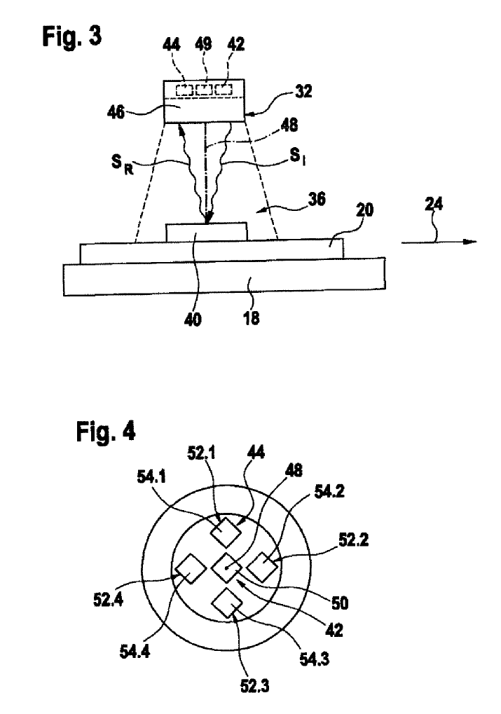

FIG. 3 shows a schematic illustration of the recognition unit with a transmitting unit for transmitting radiation into the reaction area, with a sensor unit and with an examination object,

FIG. 4 shows a transmitting means of the transmitting unit and sensor means of the sensor unit, viewed from the front,

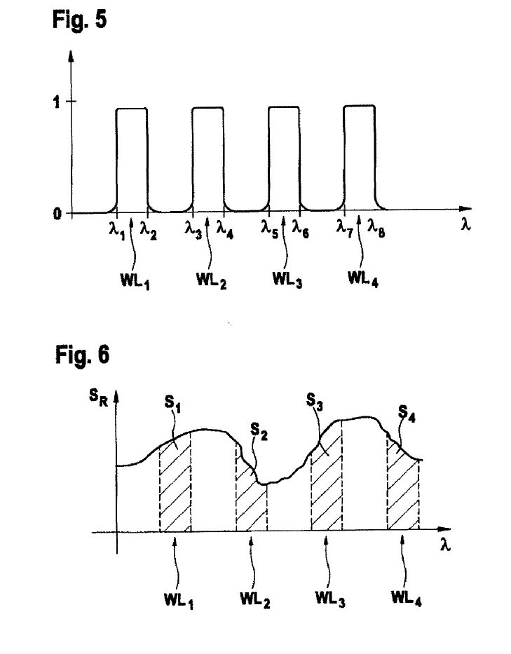

FIG. 5 shows the profile of the transmission factor of the sensor unit as a function of the wavelength,

FIG. 6 shows the reflection spectrum of radiation reflected by the reflection object, as a function of the wavelength,

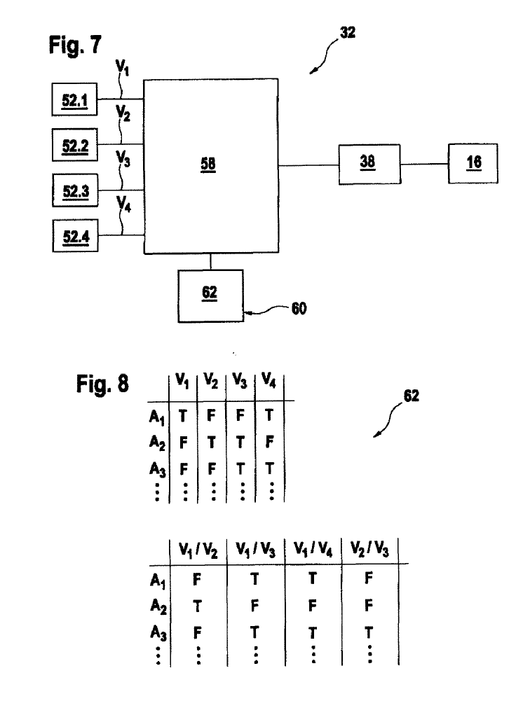

FIG. 7 shows an internal circuit of the recognition unit,

FIG. 8 shows a database stored in the recognition unit,

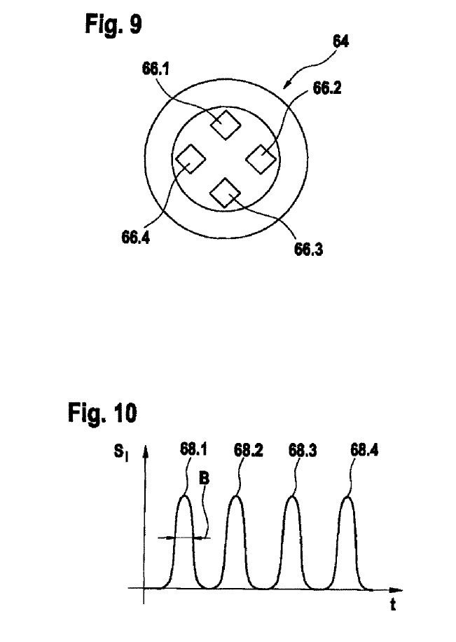

FIG. 9 shows an alternative transmitting unit of the recognition unit for production of pulses, and

FIG. 10 shows the intensity of radiation produced by the transmitting unit from FIG. 9.

### DESCRIPTION OF THE EXEMPLARY EMBODIMENTS

FIG. 1 shows a side view of a machine tool 10 in the form of a table-type circular saw. The machine tool 10 has a tool 12 which is in the form of a disk-type saw blade, which is driven to rotate during sawing operation by means of a drive unit 16 which is arranged in a drive housing 14 and is in the form of an electric motor. A sawing table 18 is arranged supported on the drive housing 14, on which sawing table 18 a workpiece 20 to be machined can be placed. In order to protect an operator the machine tool 10 has a protective shroud 22 which, when the machine tool 10 is not being operated, surrounds that part of the tool 12 which projects out of the sawing table 18. In order to machine the workpiece 20, it is moved by the operator in a manner known per se in a working direction 24 in the direction of the tool 12, using one hand 26, as illustrated schematically in the figure. During this process, the protective shroud 22, which is mounted such that it can rotate about a rotation axis 28, is pivoted upward by the workpiece 20, thus releasing the tool cutting edge.

In order to improve the operator safety, the machine tool 10 is provided with a machine tool monitoring device 30. The machine tool monitoring device 30 has a recognition unit 32 which is provided to recognize the presence of human tissue in a machine tool working area 34 of the machine tool 10. The machine tool working area 34 is shown from above in FIG. 2, in the form of a plan view of the machine tool 10. For the sake of clarity, the protective shroud has not been illustrated in FIG. 2. The recognition unit 32 has a reaction area 36, which is associated with the operation of an actuator unit 38 which is coupled to the drive unit 16 and is operatively connected to the recognition unit 32 (see FIG. 7). When the recognition unit 32 recognizing the presence of human tissue in the reaction area 36, an operating signal is transmitted to the actuator unit 38, which uses this operating signal to stop the drive unit 16 and to immediately brake the saw blade with the aid of an emergency braking device, which is not illustrated in any more detail. The reaction area 36 corresponds to a subarea of the machine tool working area 34, which is arranged in the working direction 24 in front of the tool 12. However, at this point, it should be noted that the reaction area need not in principle be within a machine tool working area. In fact, a reaction area can be defined in any desired area. In the illustrated example, the recognition unit 32 is arranged in the protective shroud 22, to be precise in the front area of the protective shroud 22, arranged in front of the tool 12 in the working direction 24. In an alternative embodiment, the recognition unit 32 may be arranged on a splitter, on a parallel stop, and/or on a cantilever arm above the sawing table 18.

The principle of operation of the recognition unit will be described with reference to FIG. 3, which illustrates a schematic view of the sawing table 18, the workpiece 20 and the recognition unit 32. For the sake of clarity, the tool 12 and the protective shroud 22 are not shown. An examination object 40 is arranged in the reaction area 36 on the workpiece 12. This examination object 40 may, in particular, be the hand 26 of the operator. The recognition unit 32 has a transmitting unit 42, which is illustrated schematically in the figure and transmits radiation S_{I} into the reaction area 36 during operation. This radiation S_{I} is reflected by the examination object 40, and is received as radiation S_{R} by a sensor unit 44, which is illustrated schematically in the figure, in the recognition unit 32. An optics unit 46 is positioned in front of the transmitting unit 42 and the sensor unit 44. The optics unit 46 has a lens unit (not illustrated) which defines the boundaries of the reaction area 36 into which the radiation S_{I} is transmitted. Furthermore, the lens unit is designed to limit the sensitivity of the sensor unit 44 to radiation S_{R} reflected in the reaction area 36. The optics unit 46 has an optical axis 48. The machine tool monitoring device 30 furthermore has a marking unit, which is illustrated schematically in FIG. 3 and, during operation of the recognition unit 32, marks the reaction area 36 of the recognition unit 32 by projection onto the sawing table 18. For example, the marking unit 49 may be in the form of a laser marker. Alternatively or additionally, the reaction area 36 may be marked by the transmitting unit 42, which produces a radiation component in the visible range.

FIG. 4 shows the transmitting unit 42 and the sensor unit 44 of the recognition unit 32 in a front view, in which the optical axis 48 passes through the plane of the drawing. The transmitting unit 42 has a transmitting means 50, which is in the form of an LED. Four sensor means 52 of the sensor unit 44 are arranged in the immediate vicinity of the transmitting means 50, and are each in the form of a photo diode.

The sensor means 52 in each case have a sensitivity range 54 which is intended for radiation detection in each case in a different wavelength range WI₁=[λ₁,λ₂], WL₂=[λ₃,λ₄], WL₃=[λ₅,λ₆], and WL₄=[λ₇,λ₈]. This is illustrated schematically in FIG. 5. FIG. 5 shows the profile of the transmission factor of the sensor unit 44 as a function of the wavelength λ, of the reflection radiation S_{R} received by the sensor unit 44. By way of example, the wavelength range in WLᵢ has a central wavelength of 375 nm, 450 nm, 740 nm, 840 nm and 1550 nm, and are in the form of a narrow band, in each case with a bandwidth of about 10 nm. For narrowband filtering of the detected radiation S_{R}, the sensor unit 44 may be provided in addition to the sensor means 52 with a system of filter components, positioned in front of the sensor means 52. If the sensor means 52 are in the form of selective photo diodes, narrowband filtering is inherent to the system, as a result of which further filter components can advantageously be avoided. Alternatively or in addition to photo diodes, the sensor means 52 may also be in the form of CCD or CMOS arrays, InGaAs detectors, pyro-electric detectors, etc.

The wavelength ranges WL₂, WL₃, WL₄ are arranged in the infrared spectrum. In particular, these wavelength ranges WL₂, WL₃, WL₄ are each in a region of the near infrared spectrum IR-A with the limit values [700 nm, 1500 nm]. The wavelength range WL₁ is arranged at least partially in the visible range of the electromagnetic spectrum. Alternatively or additionally, wavelength ranges can be chosen in the infrared ranges IR-B (1.5-3 μm) and IR-C (3-15 μm). Together with the transmitting means 50, the transmitting unit 42 produces radiation which comprises the wavelength ranges WLᵢ as shown in FIG. 5.

The principle of recognizing the presence of human tissue in the reaction area 36 of the recognition unit 32 will be explained with reference to FIGS. 6, 7 and 8. FIG. 6 shows the reflection spectrum of the radiation S_{R} reflected by the examination object 40 and detected by the sensor means 52. This reflection spectrum corresponds to the distribution of the signal intensity as a function of the wavelength λ of the radiation S_{R}. The sensor means 52, or the sensitivity ranges 54, in each case detect a portion of the reflection spectrum in the corresponding wavelength ranges WLᵢ. At their output terminals, the sensor means 52 each produce a radiation characteristic variable which is in each case in the form of an electrical voltage. By way of example, the radiation characteristic variable V₁ is proportional to the signal intensity S₁ of the radiation S_{R} integrated over the wavelength range WLᵢ and shown in shaded form in FIG. 6.

As can be seen from FIG. 7, the radiation characteristic variables Vᵢ are passed to an input of an evaluation means 58 for the recognition unit 32. In a further variant, it is feasible for the radiation characteristic variables Vᵢ to be amplified. During evaluation, the radiation characteristic variables Vᵢ are compared by means of logic operations with values in a database 62, which is stored in a memory unit 60 of the recognition unit 32. This database is illustrated schematically in FIG. 8. In a first evaluation strategy, the detected radiation characteristic variables Vᵢ are compared with stored values A₁, A₂, A₃, etc. Each pair (Vᵢ, Aᵢ) is associated with one recognition variable, which can assume the values “false” (F) or “true” (T). The value “F” precludes presence of human tissue in the reaction area 36. In a second, alternative or additional, evaluation strategy, the evaluation means 58 determines ratios V₁/V₂; V₁/V₃ etc. between the various radiation characteristic variables V₁. These ratios are compared with stored values A₁, A₂, A₃, etc. by which means, as described above, it is possible to deduce the presence of human tissue in the reaction area 36. A recognition process independent of intensity can be carried out by the formation of ratios. Furthermore, information relating to the spectral sensitivity of the sensor means 52 can be stored in the memory unit 60, and can be used for evaluation of the radiation characteristic variables Vᵢ.

The recognition unit 32 described here is an analog recognition unit, in which the reflected radiation S_{R} is detected and evaluated exclusively in an analog form. In this case, particularly effective recognition can be achieved on the basis of short detection and evaluation times. It is likewise feasible to use analog and digital signal processing means in a combined form, or to use digital signal processing means exclusively.

The transmitting means 50 transmits radiation with a radiation intensity which is constant over time. In one alternative embodiment variant, the recognition unit 32 has an alternative transmitting unit 64, which transmits radiation with a variable intensity into the reaction area 36. This is illustrated in FIGS. 9 and 10. FIG. 9 shows the sensor unit 64 which produces radiation S_{I}, which has a series of pulses 68 and is illustrated in FIG. 10. FIG. 10 shows the profile of the intensity of the radiation S_{I} as a function of the time t. A pulse 68 has a width B of about 100 μs. The transmitting unit 64 is intended to transmit radiation successively in the wavelength ranges WL₁ to WL₄. In this case, the pulses are each associated with different wavelength ranges WL₁ to WL₄ in a sequence of four successive pulses 68.1 to 68.4. The pulses 68 correspond to radiation which is transmitted in a respectively different wavelength range WLᵢ. For this purpose, a transmitting unit 64 has a plurality of transmitting means 66.1 to 66.4, which are each then provided in order to transmit in a different wavelength range WL₁ to WL₄. In this case, a transmitting means 66.1 for the pulse 68.1 corresponds to the wavelength range WL₁, etc. Alternatively, it is also possible to use transmitting diodes, which can each transmit radiation in at least two of the wavelength ranges WL₁. For example, the transmitting means 66 may each be in the form of LEDs. Such successive transmission in different wavelength ranges WLᵢ means that there is no need for complex filtering of the detected reflected radiation S_{R}. The machine tool monitoring device 30 can therefore be used to monitor a reaction area 36 of the machine tool working area 34 which, as a workpiece feed area, represents a danger area of the machine tool 10. The machine tool monitoring device makes it possible to distinguish between human tissue and materials to be machined with the aid of the machine tool 10, as a result of which the saw blade of the machine tool 10 can be brought to rest immediately with the aid of the actuator unit 38 as soon as, for example, a hand 26 of a user is detected within the reaction area 36 with the aid of the machine tool monitoring device 38. As is illustrated in FIG. 1, the machine tool has an activation and a deactivation unit 70, which is operatively connected to the machine tool monitoring device 30. This activation and deactivation unit 70 is designed such that the extent to which it can be operated by an operator is dependent on an authorization level of the user. For this purpose, the activation/deactivation unit 70 has a laser unit, which is not illustrated in any more detail, and which can be used to read portable memory media, in which authorization levels of users are stored. The user can activate or deactivate the machine tool monitoring device 30—possibly within predetermined limits—as a function of the detected authorization level of that user. Such operation of the activation/deactivation unit 70 as a function of the authorization level makes it possible to allocate different rights to different users. For example, a craftsman who has a large amount of experience with use of the machine tool 10 can completely deactivate the machine tool monitoring device 30, while an inexperienced trainee is not allowed to carry out such deactivation.

It should be evident that the machine tool monitoring devices of the type described here can be used to monitor widely different machine tools, in the case of which a user can/must/should intervene occasionally or regularly in the working process of the machine tool. Furthermore, the machine tool area which can be monitored with the aid of a machine tool monitoring device according to the invention is not restricted to a machine tool working area in the vicinity of the tool. In fact, all machine tool areas can be monitored which can cause a potential hazard to the user.

Finally, it should be evident that the present invention is not restricted to the embodiments described above. In fact, variations and changes are possible without departing from the scope of protection of the present invention, as defined by the attached claims.

1. A machine, comprising:
a tool, wherein at least one predetermined detection area is defined in relation to the tool;
a drive unit configured to move the tool in a path of movement; and
a recognition unit configured to recognize presence of at least one type of material in the at least one predetermined detection area by spectral evaluation of radiation,
wherein the recognition unit has (i) a sensor unit, which has at least one sensitivity range for radiation detection in a wavelength range, which is arranged in the electromagnetic range, (ii) a transmitting unit configured to transmit radiation having at least one radiation component in the wavelength range, and (iii) an evaluator configured to detect presence of the at least one type of material in the at least one predetermined detection area based on radiation detected by the sensor unit, and
wherein the evaluator is operatively connected to the transmitting unit.

2. The machine as claimed in claim 1, wherein the recognition unit is configured for presence recognition by evaluation of a reflection spectrum of radiation which is reflected by an examination object located in the one predetermined detection area.

3. The machine as claimed in claim 1, wherein the wavelength range is arranged at least partially in the infrared spectrum.

4. The machine according to claim 3, wherein the wavelength range is a near-medium infrared range or a near infrared range.

5. The machine as claimed in claim 1, wherein the wavelength range is a narrow band.

6. The machine as claimed in claim 1, further comprising an optics unit configured to define at least one reaction area of the recognition unit.

7. The machine as claimed claim 1, further comprising a marking unit configured to mark the at least one predetermined detection area or the at least one reaction area.

8. The machine as claimed in claim 1, wherein the transmitting unit is configured to transmit radiation in the wavelength range and in at least one further wavelength range.

9. The machine as claimed in claim 8, wherein the transmitting unit has a plurality of transmitting unit modules, wherein each of the transmitting unit modules is configured to transmit radiation in a different wavelength range in relation to each other.

10. The machine as claimed in claim 8, wherein the transmitting unit has at least one transmitting diode configured to transmit radiation in at least two mutually different wavelength ranges.

11. The machine as claimed in claim 8, wherein the sensor unit has at least one further sensitivity range configured for radiation detection in a further wavelength range.

12. The machine as claimed in claim 8, wherein the evaluator of the recognition unit is configured to recognize presence of the at least one type of material based on a ratio of at least two radiation characteristic variables, which are each associated with one radiation component in a different wavelength range.

13. The machine as claimed in claim 1, further comprising:
at least one actuator unit operatively coupled to one of the tool and the drive unit; and
a decision unit configured to activate the at least one actuator unit based on detection of presence or absence of the at least one type of material.

14. The machine as claimed in claim 1, further comprising an activation and/or deactivation unit configured to active or deactive the the recognition unit.

15. The machine as claimed in claim 14, wherein the extent to which the recognition unit can be activated and/or deactivated by an operator with the aid of the activation and/or deactivation unit is dependent on an authorization level of the user.

16. (canceled)

17. The machine as claimed in claim 16, further comprising (i) an object movable in relation to the tool, and (ii) a work piece movable in relation to the tool, wherein:
the object includes a first material,
the work piece includes a second material, and
first material is configured to be detected more readily by the recognition unit than the second material.

18. The machine as claimed in claim 17, wherein a surface of the object is coated with the first material.

19. The machine as claimed in claim 17, wherein the object is a working glove.

20. The machine as claimed in claim 1, wherein the tool is at least partially located in the at least one predetermined detection area.

21. The machine as claimed in claim 1, wherein:
the tool includes a disk-type saw blade, and
the drive unit is configured to rotate the disk-type saw blade.
